(19) United States
(12) Patent Application Publication
(10) Pub. No.: US 2001/0056354 A1
(43) Pub. Date: Dec. 27, 2001

(54) Methods and systems for requesting services from service providers over a communications network

(76) Inventors: Michelle Stacy Feit, Valley Cottage, NY (US); Ivan John O'Sullivan, Sudbury, MA (US); Stevan Richard Roberts, Port Washington, NY (US)

Correspondence Address: FOLEY, HOAG & ELIOT, LLP, PATENT GROUP, ONE POST OFFICE SQUARE, BOSTON, MA, 02109, US

(21) Appl. No.: 09/850,414

(22) Filed: May 7, 2001

Related U.S. Application Data
(60) Provisional application No. 60/202,252, filed on May 5, 2000.

(51) Int. Cl. G06F 17/60

(52) U.S. Cl. 705/1; 705/26

(57) ABSTRACT

The present invention provides systems and methods for implementing a computerized service provider request service for delivering service requests for multiple subscriptions, goods, memberships, etc., to many service providers in a efficient and non-redundant manner. The present invention comprises a server computer hosting a service provider request service accessible via client system to a plurality of clients and a plurality of service providers, a database of information concerning the services available from a plurality of service providers who offer services to qualified clients, and wherein the service provider request service including an integrated user interface comprising controls whereby a client submits qualification information, the service provider request service being available via a communications network to assist a client in delivering service requests to a plurality of service providers who offer services to qualified clients.

This case claims priority to U.S. Provisional Application No. 60/202,252 entitled “Method and System for Requesting Subscription, Goods, Memberships, and Services Over a Communication Method” and filed May 5, 2000, the contents of which are herein incorporated by reference.

### FIELD OF THE INVENTION

The present invention relates generally to the efficient acquisition of information, goods, and services. More particularly, the invention enables a client to employ a communications network (e.g., the Internet, a WAN, a MAN, a LAN, a traditional telephone network, a wireless network, etc.) to simultaneously request multiple subscriptions, goods, memberships, and/or services in an efficient and non-redundant manner, especially where the client must first qualify for the subscriptions, goods, memberships, and/or services (e.g., by satisfying predetermined criteria).

### BACKGROUND OF THE INVENTION

Certain publishers, vendors, non-profit entities, and service providers offer people subscriptions, goods, memberships, and services depending on certain criteria, such as Job Title, Organization Size, Scope Of Purchasing Authority, Annual Budget, Level Of Purchasing Influence, and the like. For example, an engineer may qualify for free subscriptions to numerous trade journals, such as Nasa Tech Briefs, Java Developers Journal, XML Developers Journal, Electronic Products, EDN. Additionally, the engineer may qualify for free product samples such as integrated circuits, test equipment tools, cleaning supplies, etc., from a multitude of vendors such as Analog Devices, National Semiconductor, New Pig Corp., 3M Corp., and the like. The engineer may also qualify for memberships to numerous professional associations, such as IEEE for example. Finally, the engineer may qualify for free online services, such as free internet access and/or pushed e-mail updates from such sources as The Financial Times, Motley Fool, and Free Internet.com.

To qualify for these free subscriptions, goods, and services, however, typically the engineer must first satisfy predetermined criteria that is established by the individual publishers. Often, this is accomplished by completing a separate Qualification Form (e.g., a pull-out postcard, an online form, etc.), for each publisher, vendor, non-profit entity, and service provider. Each separate Qualification Form may solicit qualification data such as Job Title, Organization Size, Scope Of Purchasing Authority, Annual Budget, Level Of Purchasing Influence, and the like. To receive the free subscriptions, goods or services the engineer must complete each Qualification Form and forward them (e.g., via US mail, Internet, etc.) to the appropriate publisher, vendor, non-profit entity, and service provider. Then, each publisher, vendor, non-profit entity, and service provider analyzes its completed Qualification Form (i.e., the provided qualification data) to determine whether the engineer qualifies for their subscription(s), good(s), membership(s), and/or service(s). If the engineer does not meet the criteria for a particular publisher (e.g., the engineers Job Title does not qualify), then the engineer will not receive the subscription to that publishers publication(s). Likewise, if the engineer does not meet the criteria for a particular vendor (e.g., the engineer's level of purchasing influence is insufficient), then the engineer will not receive that vendor's sample(s). Ultimately, the engineer could end up investing a substantial amount of time and effort in completing qualification forms and yet only receive a handful of the desired subscriptions, goods, memberships, and/or services. Worst of all, the engineer may invest substantial time and effort and receive none of the desired subscriptions, goods, memberships, and/or services.

Therefore, there is a need for methods and systems for requesting multiple subscriptions, goods, memberships, and/or services in an efficient, non-complex, and non-redundant manner.

### SUMMARY OF THE INVENTION

The present invention provides advantages over the inefficient and time-consuming systems and methods for requesting services from a plurality of service providers found in the prior art. The present invention provides systems and methods for implementing a computerized service provider request service for delivering service requests to many service providers in a efficient and non-redundant manner.

The present invention teaches an integrated user interface that enables a user (i.e., a client or subscriber) to employ a communications network (e.g., the Internet, a WAN, a LAN, a wireless network, a traditional telephone network, etc.) to simultaneously request multiple subscriptions, newsletters, goods, promotional materials, information, data, samples, memberships, and/or other services, etc. (herein collectively referred to as “services”) from multiple content providers, publishers, vendors, non-profit entities, etc. (herein collectively referred to as “service providers”) in an efficient and non-redundant manner.

In one embodiment, a user (i.e., a client) employs a client computer system to access an integrated user interface from a HTTP server over the Internet. The integrated user interface employs an online form, i.e., a data gathering engine, that has input fields which prompt the user to enter non-redundant information, such as the class (or classes) of subscriptions, goods, memberships, and/or services that the client is interested in receiving and qualification information such as job title, organization size, scope of purchasing authority, annual budget, level of purchasing influence, for example. The client can enter the non-redundant information into the input fields using input devices, such as a keyboard, a mouse, a touch-screen, a voice recognition software application, etc. Then, a parsing engine can normalize the non-redundant information into a common data format, a filtering engine can process the common data format and generate a qualified data format request wherein the qualified data format specifies which subscription(s), good(s), memberships(s), and/or service(s) that the client qualifies for. Then, a formatting engine can translate the qualified data format request into one or more data formatted requests associated with the appropriate publisher(s), vendor(s), non-profit entity(ies), and/or service provider(s) providing the subscription(s), good(s), memberships(s), and/or service(s) that the client qualifies for. Finally, a transmitting engine can forward the translated formatted requests to the appropriate publisher(s), vendor(s), non-profit entity(ies), and/or service provider(s).

In another embodiment, a client can employ a telephone set to access an integrated user interface over a conventional telephone network. The integrated user interface can further employ voice recordings to prompt the user to enter non-redundant information and the qualification information. The client can enter the non-redundant information by either speaking into the telephone set or by pressing keypads thereon.

In yet another embodiment, a client can employs a wireless device (e.g., a mobile telephone, a palm pilot, a pager, etc.) to access an integrated user interface over a wireless network (e.g., CDPD, CDMA, GSM, PDC, PHS, TDMA, FLEX, ReFLEX, iDEN, TETRA, DECT, DataTAC, and Mobitex), the Internet, or a conventional telephone network. The integrated user interface can further employ voice recordings to prompt the user to enter non-redundant information. The client may enter the non-redundant information by either speaking into the wireless device or by pressing keypads thereon, or by electronic pen.

In accordance with one aspect of the present invention, a method of delivering service requests to a plurality of service providers who offer services to qualified clients includes the steps of obtaining from each service provider the qualification requirements needed to receive the offered services, gathering qualification information from a client, generating a qualified data format request by correlating the gathered qualification information to the qualification requirements established by the service providers, translating the qualified data format request into at least one formatted request for a service provider for which the client qualifies to receive services from, and transmitting the translated formatted request over a communications network to the service provider. The qualified data format request can specify which subscriptions, goods, memberships, etc., i.e., services, that the client qualifies for. The formatted request can be in a data format that is associated with one of the service provider providing the service for which the client qualifies to receive. Additionally, the gathering of the qualification information can be done in a non-redundant manner so that the client only has to provide any given qualification information once.

In accordance with a further aspect of the present invention, the service request method can include presenting a list of the service providers and the services offered by such service providers to a client, wherein the client chooses the services that the client is interested in receiving. The qualification information can then be gathered based upon the services that are chosen by the client.

In accordance with a further aspect of the present invention, the service request method can include compiling the client qualification information into a common data format protocol prior to generating the qualified data format request.

In accordance with a further aspect of the present invention, the service request method can include communicating with a client to promote the generation of requests for services to the service providers. The step of communicating with a client can be done to target certain clients to promote these clients' participation in service provider request service disclosed herein.

In accordance with another aspect of the present invention, the service request method can include storing the gathered client qualification information onto a database, and/or generating and storing a record of the transmitted formatted request onto a database.

In accordance with a further aspect of the present invention, the service request method can include communicating with a client to promote the generation of additional requests for services to the service providers, wherein the step of communicating is based upon a transmitted formatted request record associated with the client. The communication could identify other services that the client might be interested in receiving.

In accordance with a further aspect of the present invention, the service request method can include communicating with a client to initiate a request for services that had been previously requested by the client. The communication could be used to notify the client that a previously requested service is about or has already expired, and solicit the client re-request the service.

The service request method of the present invention can be implemented as a set of processing instructions, stored in a computer-readable storage medium, for a directing a computer, such as a server hosting a service request service, to carryout the steps of the method. For example, the processing instructions can instruct the server computer to obtain qualification requirements from service providers who offer services to qualified clients, present a list of the service providers and the services offered by such service providers to a client, generate a second list of the services and service providers, wherein the second list reflects the services that the client is interested in receiving, gather qualification information from a client in a non-redundant manner based upon the services that are chosen by the client, generate a qualified data format request by correlating the gathered qualification information to the qualification requirements established by the service provides, translate the qualified data format request into at least one formatted request for a service provider for which the client qualifies to receive services from, and transmit the formatted request over a communications network to the service provider.

In accordance with a further aspect of the present invention, the processing instructions can instruct the server computer to compile the client qualification information into a common data format protocol prior to generating the qualified data format request.

In accordance with a further aspect of the present invention, the processing instructions can instruct the server computer to communicate with a client to promote the generation of requests for services to the service providers.

In accordance with a further aspect of the present invention, the processing instructions can instruct the server computer to store the gathered client qualification information onto a database, and/or generate and store a record of the transmitted formatted request onto a database.

In accordance with a further aspect of the present invention, the processing instructions can instruct the server computer to communicate with a client to promote the generation of additional requests for services to the service providers, wherein the communication is based upon a transmitted formatted request record associated with the client, and/or communicate with a client to initiate a request for services that had been previously requested by the client.

A system for implementing a computerized service provider request service according to the present invention includes a server computer hosting a service provider request service accessible via client system to a plurality of clients and a plurality of service providers. The system further includes a database of information concerning the services available from a plurality of service providers who offer services to qualified clients. The service provider request service includes an integrated user interface comprising controls whereby a client submits qualification information, the service provider request service being available via a communications network.

In accordance with a further aspect of the present invention, the system can include a database for storing the gathered client qualification information and/or a record of the service requests delivered to a service provider.

In accordance with a further aspect of the present invention, the integrated user interface can further include a data gathering engine for gathering qualification information from a client, a filtering engine for generating a qualified data format request that identifies which services the client qualifies for, a formatting engine for translating the qualified data format request into at least one data format that is associated with a service provider system, and, optionally, a parsing engine for normalizing the non-redundant client qualification information into a common data format protocol.

In accordance with another aspect of the present invention, the data gathering engine of the integrated user interface can facilitate the gathering of client qualification information in a non-redundant manner.

In accordance with a further aspect of the present invention, the integrated user interface can further include a messaging engine for communicating with a client to promote the generation of requests for services to the service providers.

Other objects of the invention will, in part, be obvious, and, in part, be shown from the following description of the systems and methods shown herein.

### BRIEF DESCRIPTION OF THE DRAWINGS

The foregoing and other objects and advantages of the invention will be appreciated more fully from the following further description thereof, with reference to the accompanying drawings wherein;

FIG. 1 depicts schematically the structure of a system according to the invention that employs a computer network to simultaneously request multiple subscriptions, goods, memberships, and/or services in an efficient and non-redundant manner;

FIG. 2 depicts in more detail the structure of a system for simultaneously requesting multiple subscriptions, goods, memberships, and/or services in an efficient and non-redundant manner;

FIG. 3 depicts an embodiment of the server of the invention in more detail;

FIG. 4 illustrates the flowchart of one method of delivering service requests to a plurality of service providers in accordance with the of the present invention;

FIG. 5 illustrates the flowchart of an alternative method of delivering service requests to a plurality of service providers in accordance with the of the present invention;

FIG. 6 illustrates the flowchart of yet another alternative method of delivering service requests to a plurality of service providers in accordance with the of the present invention.

### DESCRIPTION OF AN ILLUSTRATIVE EMBODIMENT

To provide an overall understanding of the invention, an illustrative embodiment will now be described, including a system that enables a user to employ a communications network (e.g., the Internet, a WAN, a MAN, a LAN, a traditional telephone network, a wireless network, etc.) to simultaneously request multiple magazine subscriptions from multiple publishers in an efficient and non-redundant manner, especially where the user must first qualify for the subscriptions (e.g., by satisfying predetermined criteria). Although this illustrative embodiment illustrates requesting magazine subscriptions, especially free magazine subscriptions, the inventive concept can also be used to simultaneously request multiple goods, memberships, and/or services from multiple vendors, non-profit entities, and service providers in an efficient and non-redundant manner. Thus, it will be understood by one of ordinary skill in the art that the systems and methods described herein can be adapted and modified for other suitable applications and that such other additions and modifications will not depart from the scope hereof.

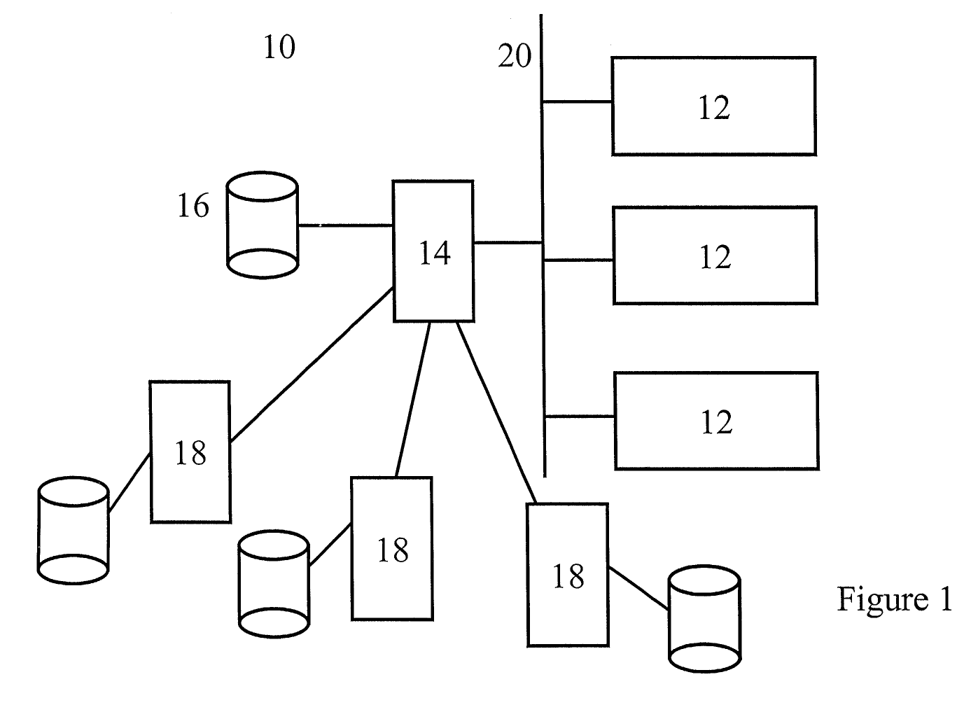

FIG. 1 depicts one embodiment of a system 10 according to the invention for implementing a computerized service provider request service to assist a client in delivering service requests to a plurality of service providers in an efficient and non-redundant manner. Specifically, FIG. 1 illustrates a system 10 wherein a plurality of client systems 12 may connect via a network 20 to a server 14. The server 14 may connect to a proprietary database 16 and may similarly connect, optionally by direct secure lines, to a plurality of service providers 18. The elements of the system 10 can include commercially available systems that have been arranged and modified to act as a system according to the invention. The system 10 may allow a client to simultaneously request services, such as magazine subscriptions or promotional materials for example, from a plurality of service providers in an efficient and non-redundant manner, and optionally may generate records of these transactions, i.e., the delivery of such requests to the service providers. The system 10 of FIG. 1 utilizes a network 20, such as the Internet, for example, to allow a client (i.e., a subscriber) who is using a client system 12 to access a central network server, i.e., the depicted server 14, and to optionally log into an account maintained by that server and to employ the request services (which may be authorized for that account) to request services from a plurality of service providers 18 who offer services to qualified clients in an efficient and non-redundant manner.

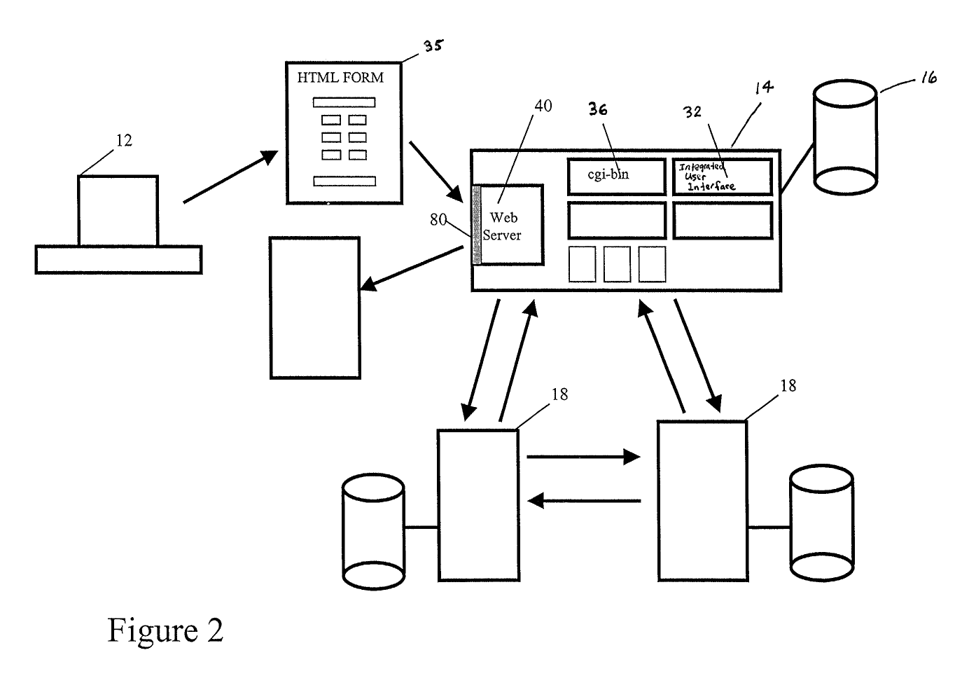

For example, in the embodiment of the invention depicted in FIG. 1, the server 14 can deliver a HTML page to the client systems 12. The HTML page may serve as an integrated user interface 32 (shown in FIG. 2). The integrated user interface 32 can present an integrated form that has user-input fields (i.e., controls) to a client using a client system 12. By using input devices (not shown) such as a keyboard, a mouse, a touch-screen, touch tone buttons, a voice recognition software application, for example, the client can enter qualification information into the user-input fields of the integrated form (of the integrated user interface 32) so the qualification information can be assembled and compiled and ultimately used to request services from a plurality of service provider 18 in an efficient and non-redundant manner.

Turning now to the elements that compose the system 10 depicted in FIG. 1, it can be seen that the system 10 includes a network based system that includes a plurality of client systems 12 that connect through a network 20, such as the Internet IP network, to a server 14. The server 14 has connections over dedicated channels, or alternatively over non-dedicated channels such as the Internet, to a plurality of service providers 18 (i.e., service providers network systems). Thus, in this way, a plurality of client systems 12 can communicate, via a transmission engine 60 of a server 14, with a plurality of service providers 18 via the network 20 and the server 14.

For the depicted system, the client system 12 can be any suitable computer system such as a PC workstation, a handheld computing device, a telephone device, a wireless communication device, or any other such device, equipped with a network client capable of accessing a network server (e.g., server 14) and capable of interacting with the server 14 so as to be able to exchange information with the server 14. In one embodiment, the network client is a Web client, such as a Web browser that can include the Netscape Web browser, the Microsoft Internet Explorer Web browser, the Lynx Web browser, or a proprietary Web browser, or a Web client that allows the client to exchange data with a Web server, an FTP server, a Gopher server, or some other type of network server. Optionally, the client system 12 and the network server 14 can rely on an unsecured communications path, such as the Internet, for accessing services on the server 14. To add security to such a communications path, the client system 12 and the server 14 can employ a security system, such as any of the conventional security systems that have been developed to provide a remote user a secured channel for transmitting data over the Internet. One such system is the Netscape secured socket layer (hereinafter “SSL”) security mechanism that provides to a remote user a trusted path between a conventional Web browser program and a Web server. Therefore, optionally and preferably, the client systems 12 and the server 14 have built-in 128 bit or 40 bit SSL capability and can establish an SSL communication channel between the client systems 12 and the server 14. Other security systems can be employed, such as those described in Bruce Schneir, Applied Crylpography (Addison-Wesley 1996), the contents of which are herein incorporated by reference. Alternatively, the system 10 may employ, at least in part, secure communications paths for transferring information between the server 14 and the client system 12. For purposes of illustration, however, the systems described herein, including the system 10 depicted in FIG. 1, will be understood to employ a public channel, such as an Internet connection through an ISP or any suitable connection, to connect the client systems 12 to the server 14.

The server 14 may be supported by a commercially available server platform such as a Sun Sparc™ system running a version of the Unix operating system and running a server capable of connecting with, or exchanging data with, a plurality of client systems 12. In the embodiment depicted in FIG. 1, the server 14 may include a Web server 40 (as shown in FIG. 2), such as the Apache Web server or any suitable Web server. The Web server 40 component of the server 14 may act to listen for requests from any of the plurality of client systems 12, and in response to such a request, may resolve the request to identify a filename or script, dynamically generates data that can be associated with that request, and returns the identified data to the requesting client system 12. The operation of the Web server 40 component of the server 14 can be understood more fully from Laurie et al., Apache, The Definitive Guide, O'Reilly Press (1997), the contents of which are herein incorporated by reference. The server 14 may also include components that extend its operation to accomplish the integrated transactions described herein, and the architecture of the server 14 may vary according to the application. For example, the Web server 40 may have built-in extensions, typically referred to as modules, to allow the server 14 to perform operations that facilitate the integrated service requests desired by a client, or the Web server 40 may have access to a directory of executable files which may be employed for performing the operations, or parts of the operations, that implement the service provider request services of the present invention. Thus, in accordance with the invention, it will be understood that the server 14 may act as a service provider request service server.

The server 14 may have access to a database 16 that stores information regarding a client's account, including information about (or links to) the plurality of service providers 18 that may be available within the network 20. The database 16 may also be used to store information regarding the clients' accounts, including client passwords, client privileges, and similar information. The database 16 may also be used to store the clients' qualification information and/or a record of the service requests that have been delivered to the service providers 18. Alternatively, more than one database 16 can be used to store the information discussed herein. The database 16 may comprise any suitable database system, including the commercially available Microsoft Access database, and can be a local or distributed database system. The design and development of database systems suitable for use with the system 10, follow from principles known in the art, including those described in McGovern et al., A Guide To Sybase and SQL Server, Addison-Wesley (1993), the contents of which are herein incorporated by reference. The database 16 may be supported by any suitable persistent data memory, such as a hard disk drive, RAID system, tape drive system, floppy diskette, or any other suitable system. The system 10 depicted in FIG. 1 includes a database 16 that is separate from the server 14, however, it will be understood by those of ordinary skill in the art that in other embodiments the database 16 can be integrated into the server 14. It will also be understood by those skilled in the art that the database 16 may consist of several separate and distinct databases.

FIG. 2 provides a data flow diagram of one example of a client's use of the service provider request service of the present invention. Specifically, FIG. 2 depicts a data flow diagram wherein a client (e.g., a subscriber), using a client system 12, utilizes the integrated user interface 32 of the server 14 to provide qualification information via an integrated user interface form 35 and a Web server 40 to the server 14. As can be seen from FIG. 2, the server 14 can act as middleware that may coordinate the operations of the inventive system.

The Web server 40 can be any suitable Web server, as discussed above, and in this example, can be understood as the Apache Web server capable of receiving requests from the client systems 12 and delivering content to port 80 and having access to a set of executable files stored in a directory accessible to the Web server 40 such as a cgi-bin directory 36. One such executable file may be a script that implements filtering such as the depicted filtering engine 46.

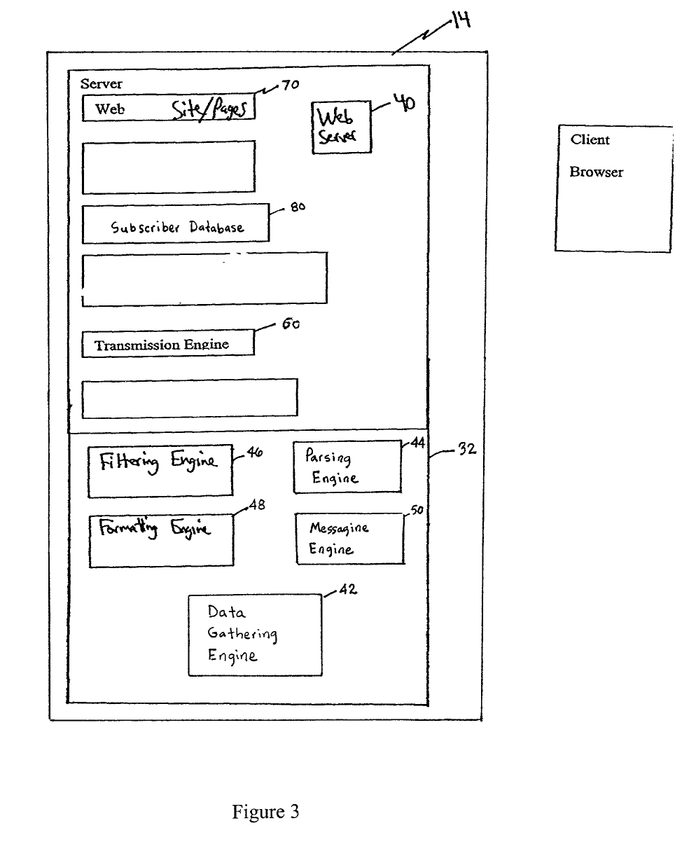

Specifically, as further depicted by FIG. 3, the server 14 can include a Web server 40, a transmission engine 60, and an integrated user interface 32, wherein the integrated user interface 32 can comprise a data gathering engine 42, a parsing engine 44, a filtering engine 46, a formatting engine 48, and a messaging engine 50. The transmission engine 60 of the server 14 can be used to deliver communications to a client systems 12 and/or the service providers 18. The data gathering engine 42 can facilitate the gathering of the qualification data from a client. The parsing engine 44 can be used to normalize the client qualification information into a common data format protocol. The filtering engine 46 can be used to generate a qualified data format request which identifies which services the client qualifies for. The formatting engine 48 can translate the qualified data format request into at least one data format that is associated with a service provider, i.e., a service provider system 18. The messaging engine 50 can be used for communicating with a client to promote the generation of requests for services to the service providers.

In an alternate embodiment, the data gathering engine 42 of the integrated user interface 32 gathers the client qualification information from a client in a non-redundant manner. This can be accomplished by assigning (i.e., programming) each of the client qualification information fields a unique identifier so that no client qualification information field is presented to a client more than once. For example, a unique identifier can be assigned to a qualification information field that is associated with a client's purchasing power. Thus, when the client is asked to provide the qualification information relating to the client's purchasing power, the client will only be prompted once to provide this qualification information. In yet another embodiment of the present invention, the data gathering engine 42 can gather the client qualification information based upon the services the client is interested in receiving. Specifically, the integrated user interface form 35 generated by the integrated user interface 32 can be dynamically generated based upon the services the client is interested in receiving. An advantage of this embodiment is that the client may only be solicited to provide the minimum qualification information needed to qualify for the services that the client is interested in receiving. In other words, if a certain qualification information field, for example, a client's age, is not required to qualify for those service for which the client is interested in receiving, then the client will not be solicited to provide this qualification information field.

In an alternate embodiment of the present invention, the messaging engine 50 of the integrated user interface 32 can communicate with a client, e.g., via email, postal mail or facsimile, based upon a record of a transmitted formatted request that is associated with the client. The communication, thus, could be to solicit the client to request additional services based upon the services that the client has requested in the past, or to inquiry whether the client wishes to re-request services which are about to (or have already) expired.

In yet another alternate embodiment of the present invention, the messaging engine 50 of the integrated user interface 32 can communicate with a client based upon a record of the client's qualification information. The communication, thus, could be to solicit the client to request new services for which the client might qualify for.

The data gathering engine 42, parsing engine 44, filtering engine 46, formatting engine 48, messaging engine 50, and the transmission engine 60 may be implemented with Perl V scripts, C language programs, or any other suitable computer-readable storage medium encoded with processing instructions for directing the operations of a computer. The design and development of the above-referenced engines may follow from principles known in the art of computer programming, including those set forth in Wall et al., Programming Perl, O'Reilly & Associates (1996); and Johnson et al, Linux Application Development, Addison-Wesley (1998), the contents of which are herein incorporated by reference. Additionally, in other embodiments, the above-referenced engines can be implemented, at least in part, by employing the operating system to restrict the execution of certain scripts and to restrict access to certain files by configuring an operating system in a selected manner. Techniques for so configuring the operating system are known in the art, including those techniques set forth in Bach, The Design of the Unix Operating System, Prentice-Hall (1986), the contents of which are herein incorporated by reference.

Service providers 18, like magazine publishers, for example, may reserve the right to offer services, e.g., subscriptions, only to qualified individuals. Service providers 18 may identify and communicate to the server 14 of the present invention the qualification requirements needed to receive the offered services. Alternatively, the operators of the server 14, or their agents, may communicate with the service providers 18 so as to obtain the service providers 18's qualification requirements. Then, based upon the qualification requirements of the service providers 18, an algorithm (or algorithms) can be created to determine whether a client will qualify for the services offered by the service providers 18. An algorithm (i.e., a computer program) to determine if a client requesting a subscription qualifies for a subscription may be as follows:

| Let X = Weight | |
|---|---|
| Let Y = Number of questions | |
| Let Σ = The Sum | |
| $\frac{\sum X}{\sum Y} = 1 = Qualified to subscribe$ | |
| $\frac{\sum X}{\sum Y} > 1 = Not Qualified to subscribe$ | |
| Example: | Weight |
| Job Function | |
| Title a | 1 |
| Title b | 1 |
| Title c | 1 |
| Title e | 1 |
| Title f | 2 |
| Title g | 2 |
| Industry | |
| Industry a | 1 |
| Industry b | 1 |
| Industry c | 1 |
| Industry d | 1 |
| Industry e | 2 |
| Industry f | 2 |
| Employee | |
| Range 1 | 2 |
| Range 2 | 1 |
| Range 3 | 1 |
| Range 4 | 1 |
| Range 5 | 1 |
| Range 6 | 1 |
| Range 7 | 1 |
| Demographic | |
| Demo 1 | 1 |
| Demo 2 | 1 |
| Demo 3 | 1 |
| Demo 4 | 1 |
| Demo 5 | 1 |
| Demo 6 | 1 |
| Demo 7 | 11 |

An algorithm as described herein, can serve as the basis of the filtering engine 46 of the integrated user interface 32 used to generate a qualified data format request which identifies the services that the client qualifies to receive.

As depicted by FIGS. 2 and 3, a client can visits a Web site 70 maintained by the server 14 and be presented with a single integrated user interface form 35 (which can be generated by the integrated user interface 32) which may detail a multiplicity of services offered by service providers 18 which they may request. The availability of services may be categorized by title within major classifications, or by any other appropriate organizational arrangement. For example, the major category of “computer publications” may have sub-classifications which represent the actual names of many different computer-related publications. A client using the inventive service may then click (i.e., select, identify, etc.) on the titles to which the client wishes to subscribe to request a subscription. This request for multiple subscriptions is made by the client at a client system 12 and received by the server system 14. After a client chooses which services, e.g., magazines, they wish to receive, the client may then presented with a single integrated user interface form 35, which may integrate and aggregate all the qualification requirement information from each of the individual service provider 18's from which services are desired. In one embodiment, the integrated user interface form 35 contains no duplicate questions; if the same information is required by more than a single service provider 18, the client need only enter that information once. Once the client, from the client system 12, has completed the consolidated, integrated user interface form 35, a single keystroke may be all that is required to submit the form for processing to the server system 14. The server system 14, via the integrated user interface 32, may then process the completed integrated user interface form 35 and compile the qualification information into multiple, completed qualified data format requests, each meeting the required information criteria and format of the requested individual service provider 18. The multiple individual qualified data format requests may then be transmitted to the appropriate service provider 18 in electronic format over a communications network 20 by the transmission engine 60 of the server 14. Optionally, the server system 14 may note (i.e., record) the date on which a client requests service from a service provider 18 and may automatically notify the client via e-mail prior to the expiration of the service, e.g., subscription, to allow the client to re-subscribe to the client's chosen service.

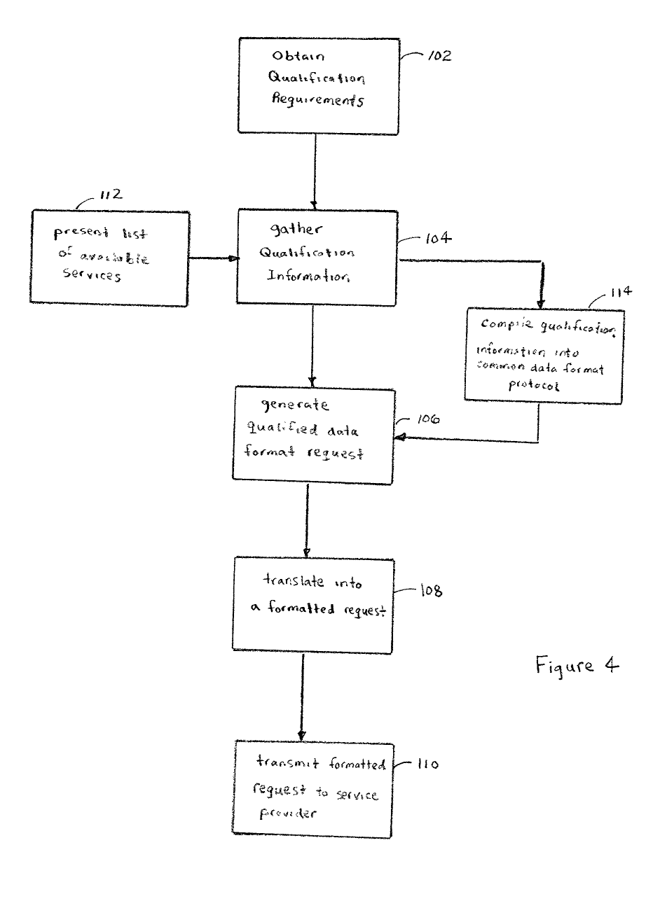

A method of delivering service requests to a plurality of service providers of the present invention is illustrated in the flowchart of FIG. 4. Initially, the service provider request service obtains from each service provider 18 the qualification requirements needed to receive the offered services, step 102. Step 102 can be achieved by having the service providers 18 providing this information on their own initiative, or alternatively, having the service providers 18 provide the qualification requirements in response to requests made by the operators of the server 14. Then the integrated user interface 32 of the server 14 facilitates the gathering of qualification information from a client, step 104. Next, a qualified data format request is generated by correlating the gathered qualification information to the qualification requirements established by the service providers, step 106, wherein the qualified data format request identifies which services the client qualifies for. Then, the qualified data format request is translated into at least one formatted request for a service provider for which the client qualifies to receive services from, step 108. Lastly, the translated formatted request is transmitted over a communications network to the appropriate service provider 18, step 110. In one embodiment of the invention, the gathering of the qualification information from a client, step 104, as discussed above, can be accomplished in a non-redundant manner. Additionally, as disclosed herein, step 104, the gathering of the qualification information can occur within a computer network environment, or alternatively, within a telephone network environment.

In some embodiments of the present invention, the method of delivering service requests to a plurality of service providers may include the step of presenting a list of the service providers and the services offered by such service providers to a client, wherein the client chooses the services that the client is interested in receiving, step 112. Step 112 can occur prior to the gathering of the qualification information, step 104. Additionally, the gathering of the qualification information, step 104, can be gathered based upon the services that are chosen by the client in step 112.

In some embodiments of the present invention, the method of delivering service requests to a plurality of service providers may further include the step of compiling the client qualification information into a common data format protocol prior to generating the qualified data format request, step 114. Step 114 can be accomplished so as to normalize the qualification information into a common data format protocol.

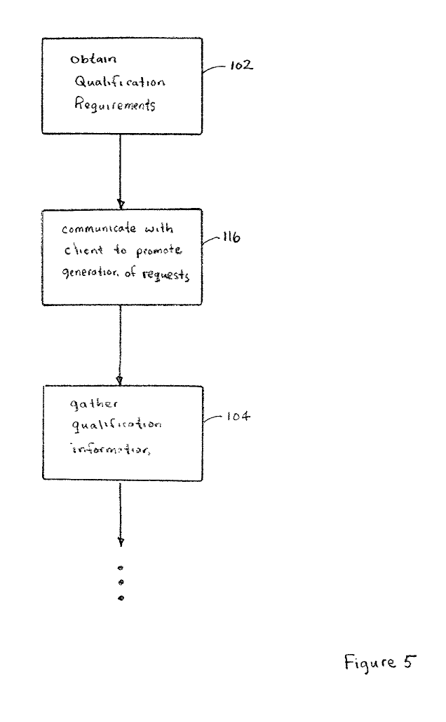

FIG. 5 illustrates the flowchart of an alternative method of delivering service requests to a plurality of service providers of the present invention that includes, in addition to the step discussed above, the step of communicating with a client to promote the generation of requests for services to the service providers, step 116. Step 116 can illustrate a targeted mailing, in that the operators of the server 14 can solicit clients to utilize the service providers request services of the present invention.

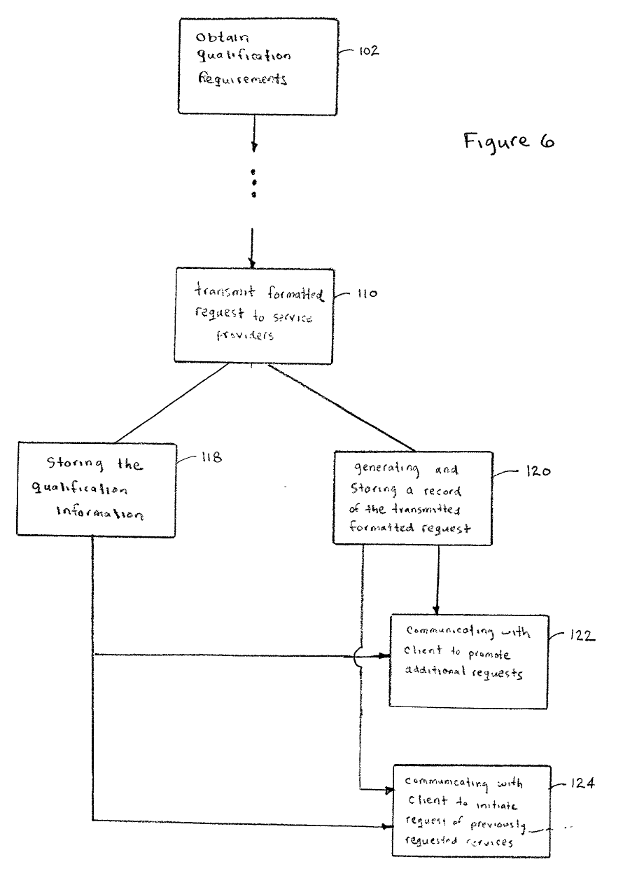

FIG. 6 illustrates the flowchart of an alternative method of delivering service requests to a plurality of service providers of the present invention that includes, in addition to the step discussed above, the steps of storing the gathered client qualification information onto a database, step 118, and generating and storing a record of the transmitted formatted request onto a database, step 120. While FIG. 6 depicts the occurrences of both steps 118 and 120 in one embodiment, there are other embodiments of the invention in which only one of these steps is present. FIG. 6 also illustrates the further steps of communicating with a client to promote the generation of additional requests for services to the service providers, step 122, and communicating with a client to initiate a request for services that had been previously requested by the client, step 124. The step of communicating, step 122, can be based upon a transmitted formatted request record associated with the client, as depicted in step 120.

An example of the nature of the interaction that may take place between a client, who is utilizing a client system 12, and the server 14 that is hosting the service provider request service of the present invention is presented below:

Step 1:

Visitor (i.e., client) surfs to Web site 70

Step 2:

Web site 70 displays Web Pages with greetings message

“Welcome to MyBizMags.com. MyBizMags offers you a way to save time by requesting subscriptions to all of your favorite publications without the need to fill out redundant qualification forms”

Step 3:

System 10 displays alphabetized list of magazine subscription Categories via the integrated user interface form 35 “Please click on an interest group”

Business & Finance

Computer, Communications, Internet, IT and

Networking

Construction

Electronics

Engineering

Government & Military

Graphics and Multimedia

Manufacturing

Retail & Distribution

Service industries

Telecommunications

Transportation

Other

Step 4:

Visitor clicks “submit” button

Step 5:

System 10 accesses database 16 and displays all magazine publication titles within an interest group

“Click next to the publication's title(s) to subscribe, re-subscribe or de-subscribe:

Yes, I wish to subscribe (re-subscribe) to the following Publications:

No, I do not wish to subscribe (re-subscribe)”

Sample Publication List

Publication 1

Publication 2

Publication 3

Publication 4

Publication 5

Publication 6

Publication 7

Etc.

Step 6:

Visitor clicks next to each publication

Step 7:

Visitor clicks ‘Submit’ button at bottom of page

Step 8:

system 10 queries the database 16 and retrieves the unique reader qualification subscription cards for each magazine to which the visitor would like to subscribe.

Step 9:

System 10 combines the qualification cards in its parsing engine into a single integrated common data format, upon which each unique question is presented only once.

Step 10:

The system 10 displays a form similar to that which follows and the following message

“Please complete the following form to request your magazine subscriptions”

First Name

Last Name

Title

Company Name

Mail Stop/PO Box

Address

Address

City

State

Zip

Business E-Mail Address

Home Address:

First Name

Last Name

P.O. Box

Street Address

City

State

Zip

Home E-Mail Address

Job Function: (Check one only)

1st job function common to all magazines

2nd job function common to all magazines

3rd job function common to all magazines etc

1st job function common to multiple magazines with the highest majority of magazines less than all

2nd job function common to multiple magazines with the highest majority of magazines less than all

3rd job function common to multiple magazines with the highest majority of magazines less than all etc

1st job function common to multiple magazines with the next highest majority of magazines less than all

2nd job function common to multiple magazines with the next highest majority of magazines less than all

3^{rd} job function common to multiple magazines with the next highest majority of magazines less than all etc

and so on . . .

1st job function unique to the magazine with title starting closest to A

2nd job function unique to the magazine with title starting closest to A

3rd job function unique to the magazine with title, starting closest to A

1st job function unique to the magazine with title starting next closest to A

2nd job function unique to the magazine with title starting next closest to A

3rd job function unique to the magazine with title starting next closest to A

and so on . . .

(Note—Additional subscriber data will be integrated in similar fashion to the above based on the data required by each publisher's BPA or ABC audit statements. The form continues with the above process for all other categories which comprise the Integrated Subscription Qualification card, which typically include such categories as:

Industry, buying influence (by product and number of locations), annual purchase volume, number of employees (at site and in company), annual sales volume, systems and products in use at company,

Step 11:

Every form must include a “qualifying” question that is required by the publisher's audit bureau (BPA—Business Publishers Association & ABC—Axxxx Bxxxx Cxxxx). A “qualifying” question is akin to a PIN number, where a subscriber will be asked for a piece of personal information that can later be verified by an auditor, that the subscriber will not forget (Following is one of the many possible-qualifying questions that we will ask)

What is the color of your eyes? (Check the answer that best describes you)

Blue

Green

Brown

Hazel

Gray

Step 12:

Visitor is informed that they will receive an automatic e-mail notification through which they will be able to re-subscribe to each magazine, unless they click to cancel the service

Step 13:

Visitor is informed they will receive information via e-mail on other trade publications of similar profile to those they have chosen, unless they click to cancel the service

Step 14:

Visitor is informed they will receive information via e-mail about products and services consistent with the interest profile, unless they click to cancel the service

Step 15:

Visitor clicks the ‘submit’ button and the integrated form is submitted to the Subscriber Database 80 on the web site system.

Step 16:

The visitor is presented with a message

“Your request for free magazine subscriptions has been received and will be presented to the publisher(s). Please allow up to 6 weeks before you receive your first publication. All subscriptions are made at the discretion of the publisher and we cannot guarantee you will receive a requested magazine”

Step 17:

The system 10 reviews the submitted form and creates a unique database record within the Subscriber Database 80 for each visitor. The unique database record notes each publication to which the visitor wishes to subscribe, the date of subscription and all answers to all questions from the form.

Step 18:

The system accesses its database 16 and retrieves the required form questions and layout for each magazine.

Step 19:

The system 10 compares the questions from the publisher database with the information contained in the visitor database and the integrated user interface 32 completes a unique visitor application form for each requested publication.

Step 20:

The filtering engine 46 compares the completed form for each magazine to the publishers guidelines for providing free subscriptions. (Publishers typically send magazines to individuals only if they have a certain level of organizational seniority, or work for companies of a certain size, or if they have certain product/service purchasing authority).

Step 21:

Determining visitor eligibility

NO: Where the visitor DOES NOT qualify for a free subscription to the magazine, an e-mail is sent by the Transmission Engine to the visitor informing them of their lack of eligibility, and where permitted by the publisher, the reason for non-qualification.

YES: Step 21

Step 21:

The system 10 converts each qualifying individual visitor magazine subscription form into an individual e-mail and the Transmission Engine 60 transmits the e-mail directly to the publisher

Step 21:

The system copies the magazine subscription to its database 16 to facilitate monthly billing to the publisher for the delivery of new subscriptions

Step 22:

The system sets a date upon which an automatic reminder e-mail will be sent by the Transmission Engine 60 on the one year aniversary of the original subscription date providing the chance for the individual to re-new their annual subscription

END

The invention also discloses a method and system for suggesting to a client, additional services that the client might find interesting and the optimal time at which the client might request such services, based on a model using data from a database of previous service request histories via a communications network. The inventive system 10 can maintain an accurate and frequently updated on-line database of the history of all service provider service requests processed via the server 14, matching multiple service requests to individual clients, and thereby maintaining an individual client service request history records over time in a subscriber database 80 (which, optionally, may be integral to the server 14 or the database 16). The subscriber database 80 can allow for the production of models explaining the likely relationships between the services offered by the service providers 18 and the clients over time. For example, the system 10 can contain information detailing that client 1 initially requested magazine A and magazine B, then waited 1 month and requested magazine C, then waited 6 weeks and requested magazine D.

For each client in the subscriber database 80, the system 10 can periodically searches for new services to which it can offer requests to such services where the client has a high probability of qualifying for a service.

The system 10 may send e-mail messages to a client, i.e., ‘New Subscription E-Mails’. The New Subscription E-Mails may contain a description of the services to which the client might like to request, a copy of a representative news or feature article, and a Web site link permitting the individual to subscribe to the magazine. The system 10 may record whether the client accepts/rejects the offer to request and may further update the model as it applies to the client, planning the next ‘New Subscription E-mail’.

Step 1:

The system maintains an accurate and frequently updated on-line database of the history of all magazine subscription requests from the Web site server in its Subscriber Database, matching multiple magazine subscription requests to individual subscribers, and thereby maintaining individual subscriber history records, over time, allowing for the production of models explaining the likely relationships between magazines and subscribers. For example, the system would contain information detailing that Subscriber 1 initially requested magazine A and Magazine B, then waited I month and requested Magazine C, then waited 6 weeks and requested Magazine D.

Step 2:

The system accesses its Subscriber Database and selects an individual subscriber record

Step 3:

The system presents the individual subscriber record to the Statistical Subscription Modeling Engine which compares the individual subscriber record to the master Subscriber Database of all magazine subscribers using an algorithm describing the subscription relationships of many other subscribers, the system indicates the titles of other magazines to which the individual subscriber might wish to subscribe, and when they might be optimally ready to subscribe to the magazine.

Step 4:

The system determines the magazine which has the highest statistical probability of appealing to the individual subscriber and when the subscriber is likely to be ready to subscribe to the magazine subscription offer.

Step 5:

The system sets an automatic reminder date on which to send an e-mail message to the subscriber, the ‘New Subscription E-Mail’. The New Subscription E-Mail contains a description of the magazine to which the visitor might like to subscribe, a copy of a representative news or feature article, and a Web site link permitting the individual to subscribe to the magazine.

Step 6:

On the pre-determined date, the system sends out the e-mail via the Transmission Engine offering the subscriber the chance to subscribe to the new trade magazine.

Step 7:

The system records whether the subscriber accepts/rejects the offer to subscribe in the Subscriber Database and updates the Statistical Subscription Modeling Engine as it applies to the subscriber, planning the next ‘New Subscription E-mail’.

END

The depicted data processing system can be a conventional data processing platform such as an IBM PC-compatible computer running the Windows operating systems, or a SUN workstation running a Unix operating system. Alternatively, the data processing system can comprise a dedicated processing system that includes an embedded programmable data processing system that can include various mechanisms, engines, and modules.

Those skilled in the art will know or be able to ascertain using no more than routine experimentation, many equivalents to the embodiments and practices described herein. It will also be understood that the systems described herein provide advantages over the prior art including the ability to simultaneously request multiple subscriptions from multiple publishers in an efficient and non-redundant manner.

Accordingly, it will be understood that the invention is not to be limited to the embodiments disclosed herein, but is to be understood from the following claims, which are to be interpreted as broadly as allowed under the law.

What is claimed is:

1. A method of delivering service requests over a communications network to a plurality of service providers who offer services to qualified clients, comprising:
obtaining from each service provider the qualification requirements needed to receive the offered services;
gathering qualification information from a client;
generating a qualified data format request by correlating the gathered qualification information to the qualification requirements established by the service providers, wherein the qualified data format request identifies which services the client qualifies for;
translating the qualified data format request into at least one formatted request for a service provider for which the client qualifies to receive services from; and,
transmitting the translated formatted request over a communications network to the service provider.

2. The method of claim 1, wherein the client qualification information is gathered in a non-redundant manner.

3. The method of claim 1, further comprising the step of:
presenting a list of the service providers and the services offered by such service providers to a client, wherein the client chooses the services that the client is interested in receiving.

4. The method of claim 3, wherein the qualification information is gathered based upon the services that are chosen by the client.

5. The method of claim 1, further comprising the step of compiling the client qualification information into a common data format protocol prior to generating the qualified data format request.

6. The method of claim 1, wherein the step of gathering client qualification information occurs within a computer network environment.

7. The method of claim 1, wherein the step of gathering client qualification information occurs within a telephone network environment.

8. The method of claim 1, wherein the offered services are subscriptions to periodicals.

9. The method of claim 1, wherein the offered services are promotional materials.

10. The method of claim 1, further comprising the step of communicating with a client to promote the generation of requests for services to the service providers.

11. The method of claim 1, further comprising the step of storing the gathered client qualification information onto a database.

12. The method of claim 1, further comprising the step of generating and storing a record of the transmitted formatted request onto a database.

13. The method of claim 12, further comprising the step of communicating with a client to promote the generation of additional requests for services to the service providers, wherein the step of communicating is based upon a transmitted formatted request record associated with the client.

14. The method of claim 12, further comprising the step of communicating with a client to initiate a request for services that had been previously requested by the client.

15. A computer-readable storage medium encoded with processing instructions for directing a computer to:
obtain qualification requirements from service providers who offer services to qualified clients;
gather qualification information from a client;
generate a qualified data format request by correlating the gathered qualification information to the qualification requirements established by the service provides, wherein the qualified data format request identifies which services the client qualifies for;
translate the qualified data format request into at least one formatted request for a service provider for which the client qualifies to receive services from; and,
transmit the formatted request over a communications network to the service provider.

16. The storage medium of claim 15, wherein gathering the qualification information from a client further comprises processing instructions for directing the computer to:
gather the client qualification information in a non-redundant manner.

17. The storage medium of claim 15, further comprising processing instructions for directing a computer to:
present a list of the service providers and the services offered by such service providers to a client, and,
generate a second list of the services and service providers, wherein the second list reflects the services that the client is interested in receiving.

18. The storage medium of claim 17, wherein gathering the client qualification information further comprises processing instructions for directing the computer to:
gather the qualification information based upon the services that are chosen by the client.

19. The storage medium of claim 15, further comprising processing instructions for directing a computer to:
compile the client qualification information into a common data format protocol prior to generating the qualified data format request.

20. The storage medium of claim 15, wherein the client qualification information is gathered via a computer network.

21. The storage medium of claim 15, wherein the client qualification information is gathered via a telephone network.

22. The storage medium of claim 15, further comprising processing instructions for directing a computer to:
communicate with a client to promote the generation of requests for services to the service providers.

23. The storage medium of claim 15, further comprising processing instructions for directing a computer to:
store the gathered client qualification information onto a database.

24. The storage medium of claim 15, further comprising processing instructions for directing a computer to:
generate and store a record of the transmitted formatted request onto a database.

25. The storage medium of claim 24, further comprising processing instructions for directing a computer to:
communicate with a client to promote the generation of additional requests for services to the service providers, wherein the communication is based upon a transmitted formatted request record associated with the client.

26. The storage medium of claim 24, further comprising processing instructions for directing a computer to:
communicate with a client to initiate a request for services that had been previously requested by the client.

27. A system for implementing a computerized service provider request service, the system comprising:
a server computer hosting a service provider request service accessible via client system to a plurality of clients and a plurality of service providers;
a database of information concerning the services available from a plurality of service providers who offer services to qualified clients;
the service provider request service including an integrated user interface comprising controls whereby a client submits qualification information, the service provider request service being available via a communications network to assist a client in delivering service requests to a plurality of service providers who offer services to qualified clients.

28. The system of claim 27, wherein the client system is a telephone device.

29. The system of claim 27, wherein the client system is a computing device.

30. The system of claim 27, wherein the offered services are subscriptions to periodicals.

31. The system of claim 27, wherein the offered services are promotional materials.

32. The system of claim 27, wherein the integrated user interface further comprises:
a data gathering engine for gathering qualification data from a client;
a filtering engine for generating a qualified data format request that identifies which services the client qualifies for; and,
a formatting engine for translating the qualified data format request into at least one data format that is associated with a service provider system.

33. The system of claim 32, wherein the data gathering engine gathers the client qualification information in a non-redundant manner.

34. The system of claim 32, wherein the data gathering engine gathers the client qualification information based upon the services the client is interested in receiving.

35. The system of claim 32, wherein the integrated user interface further comprises:
a parsing engine for normalizing the client qualification information into a common data format protocol.

36. The system of claim 32, wherein the integrated user interface further comprises:
a messaging engine for communicating with a client to promote the generation of requests for services to the service providers.

37. The system of claim 36, further comprising a second database for storing at least one of the client qualification information and a record of the service requests delivered to a service provider.

38. The system of claim 37, wherein the messaging engine communicates with a client based upon a record of a transmitted formatted request that is associated with the client.

39. The system of claim 37, wherein the messaging engine communicates with a client based upon a record of the client's qualification information.

40. A computer data signal embodied in a carrier wave for facilitating the delivering service requests over a communications network to a plurality of service providers who offer services to qualified clients, comprising:
program code for gathering qualification information from a client;
program code for generating a qualified data format request by correlating the gathered qualification information to the qualification requirements established by the service provides, wherein the qualified data format request identifies which services the client qualifies for;
program code for translating the qualified data format request into at least one formatted request for a service provider for which the client qualifies to receive services from; and,
program code for transmitting the formatted request over a communications network to the appropriate service provider.

41. The computer data signal of claim 40, wherein the program code for gathering qualification information from a client includes programming code to gather the qualification information in a non-redundant manner.

42. The computer data signal of claim 40, further comprising:
program code to present a list of the service providers and the services offered by such service providers to a client: and,
program code to generate a second list of the services and service providers, wherein the second list reflects the services that the client is interested in receiving.

43. The computer data signal of claim 42, wherein the program code for gathering the qualification information from a client further comprises program code to gather the qualification information based upon the services that the client is interested in receiving.

44. The computer data signal of claim 40, further comprising:
program code to normalizing the client qualification information into a common data format protocol.

45. The computer data signal of claim 40, further comprising:
program code to communicate with a client to promote the generation of requests for services to the service providers.

46. The computer data signal of claim 45, further comprising:
program code to store the gathered client qualification information onto a database.

47. The computer data signal of claim 45, further comprising:
program code to generate and store a record of the transmitted formatted request onto a database.

48. The computer data signal of claim 47, further comprising:
program code to communicate with a client to promote the generation of additional requests for services to the service providers, wherein the communication is based upon a transmitted formatted request record associated with the client.

49. The computer data signal of claim 47, further comprising:
program code to communicate with a client to initiate a request for services that had been previously requested by the client.
